(19) United States
(12) Patent Application Publication
(10) Pub. No.: US 2026/0261020 A1
(43) Pub. Date: Sep. 3, 2026

(54) BATTERY WIRING MODULE

(71) Applicant: SUMITOMO WIRING SYSTEMS, LTD., Mie (JP)

(72) Inventor: Hiroshi SATO, Mie (JP)

(21) Appl. No.: 18/995,830

(22) PCT Filed: Jul. 13, 2023
(86) PCT No.: PCT/JP2023/025872

§ 371 Date: Jan. 17, 2025

(30) Foreign Application Priority Data
Aug. 1, 2022 (JP) 2022-122703

(51) Int. Cl. H01M 50/569; H01M 10/48; H01M 50/204; H01M 50/503; H01M 50/507

(52) U.S. Cl. CPC H01M 50/569; H01M 10/486; H01M 50/204; H01M 50/503; H01M 50/507

(57) ABSTRACT

A case (22) of a battery wiring module has a first extension piece (41) that is locked to a first locked part (71) provided on a battery. The first extension piece (41) has: a first portion (42) that extends toward the battery; a second portion that is folded back from the first portion (42) and extends away from the battery; and a first locking part (45) that is provided in the second portion and is locked to the first locked part (71).

### TECHNICAL FIELD

The present disclosure relates to a battery wiring module.

### BACKGROUND

As disclosed in Patent Document 1, for example, a battery wiring module is attached to a high-voltage battery that is mounted as a travelling power source in vehicles such as electric vehicles and hybrid vehicles. The battery wiring module includes electric wires that are electrically connected to the battery, and a case for housing the electric wires.

### PRIOR ART DOCUMENT

### Patent Document

Patent Document 1: JP 2014-089912 A

### SUMMARY OF THE INVENTION

### Problems to be Solved

When the battery wiring module is in a state attached to the battery, there is a concern that the case will be separated, i.e., rise from the battery.

The present disclosure aims to provide a battery wiring module capable of suppressing the rising of the case.

### Means to Solve the Problem

The battery wiring module of the present disclosure is a battery wiring module that is attachable to a battery, and includes: an electric wire to be electrically connected to the battery; and a case housing the electric wire, wherein the case has an extension piece to be locked to a locked part provided on the battery, and the extension piece has: a first portion extending toward the battery; a second portion folded back from the first portion and extending away from the battery; and a locking part provided in the second portion and to be locked to the locked part.

### Effect of the Invention

The battery wiring module of the present disclosure exhibits the effect of suppressing the rising of the case.

### BRIEF DESCRIPTION OF THE DRAWINGS

FIG. 1 is a schematic plan view of a battery wiring module of an embodiment.

FIG. 2 is a perspective view of a portion of a case of the battery wiring module of the same embodiment.

FIG. 3 is a plan view of a portion of the case of the battery wiring module of the same embodiment.

FIG. 4 is a 4-4 cross-sectional view of FIG. 3.

FIG. 5 is a cross-sectional view for illustrating the operation of a first extension piece in the battery wiring module of the same embodiment.

### DETAILED DESCRIPTION TO EXECUTE THE INVENTION

### Description of Embodiments of Present Disclosure

Firstly, modes for carrying out the present disclosure are listed and described.

[1] The battery wiring module of the present disclosure is a battery wiring module that is attachable to a battery, and includes: an electric wire to be electrically connected to the battery; and a case housing the electric wire, wherein the case has an extension piece to be locked to a locked part provided on the battery, and the extension piece has: a first portion extending toward the battery; a second portion folded back from the first portion and extending away from the battery; and a locking part provided in the second portion and to be locked to the locked part.

According to this configuration, the extension piece that is locked to the locked part of the battery can hold the case such that the case is not separated from the battery. This can suppress the rising of the case. Further, the extension piece is bendable due to the folded shape formed by the first and second portions, enabling the locking part provided in the second portion to be easily locked to the locked part. Further, the first and second portions form a folded shape that protrudes toward the battery. With this, space can be secured on the opposite side to the battery relative to the extension piece.

[2] In the above item [1], the extension piece may have: a first bending point set at a base end of the first portion; and a second bending point set in a folded part between the first portion and the second portion.

According to this configuration, the first and second bending points can make the extension piece more bendable. This allows the locking part provided in the second portion to be more easily locked to the locked part.

[3] In the above item [2], when the battery side relative to the extension piece is a lower side, and an opposite side thereto is an upper side, the first bending point may be located on the upper side relative to the locking part, and the second bending point may be located on the lower side relative to the locking part.

According to this configuration, the second portion is bent in a direction approaching the first portion with the second bending point as the center when the case is fitted to the battery. The first portion is bent in a direction away from the locked part with the first bending point as the center. As a result, the locking part is displaced downward, i.e., toward the battery when engaging with the locked part. This allows the locking part of the extension piece to be easily locked to the locked part.

[4] In any of the above items [1] to [3], the case may have a sensor housing part for housing a temperature sensor for detecting a temperature of the battery, the temperature sensor may have a lead wire, and when the battery side relative to the extension piece is a lower side, and an opposite side thereto is an upper side, the lead wire may pass on the upper side of the extension piece.

According to this configuration, the lead wire of the temperature sensor passes through the space above the extension piece, allowing for efficient use of this space.

[5] In the above item [4], when the extension piece is a first extension piece, and the locked part is a first locked part, the case may have a second extension piece to be locked to a second locked part provided on the battery, and the sensor housing part may be located between the first extension piece and the second extension piece.

According to this configuration, the first and second extension pieces can hold the case on the respective sides of the sensor housing part such that the case is not separated from the battery. This can more preferably suppress the rising of a region of the case including the sensor housing part.

[6] In the above item [5], when the locking part of the first extension piece is a first locking part, the second extension piece may have: a third portion extending away from the battery; a fourth portion folded back from the third portion and extending toward the battery; and a second locking part provided in the fourth portion and to be locked to the second locked part.

According to this configuration, the second extension piece is bendable due to the folded shape formed by the third and fourth portions, enabling the second locking part provided in the fourth portion to be easily locked to the second locked part. Since the lead wire of the temperature sensor passes above the first extension piece, the positioning of the lead wire is not affected even if space is secured above the second extension piece. Thus, the second extension piece can be configured using the space above the second extension piece.

### Details of Embodiments of the Present Disclosure

Specific examples of the battery wiring module of the present disclosure are described below with reference to the drawings. The drawings may partially exaggerate or simplify configurations for convenience of description. The dimensional ratio of each part may differ between the drawings. Note that the term “opposing/facing” as used herein means that surfaces or members are at positions directly facing each other, and includes not only the case of being at positions entirely facing each other but also the case of being at positions partially facing each other. Further, the term “opposing/facing” as used herein includes both the case where another member is interposed between two portions and the case where nothing is interposed between two portions.

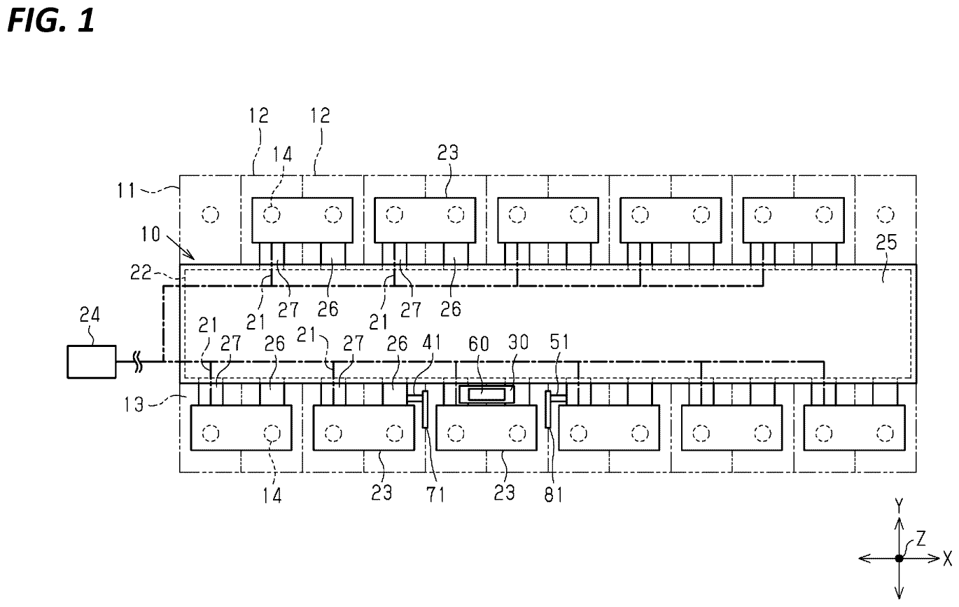

As shown in FIG. 1, a battery wiring module 10 of the present embodiment is configured, for example, to be attached to a battery 11 mounted in an electric vehicle, a hybrid vehicle, or the like. The battery 11 is, for example, a secondary battery. The battery 11 supplies electric power to a travel motor of a vehicle (not shown). Further, the battery 11 receives the supply of electric power from the travel motor and a power-generating motor in accordance with the state of charge and the driving state of the vehicle.

The battery 11 includes a plurality of battery cells 12. The battery 11 has, for example, a substantially rectangular-parallelepiped shape with the plurality of battery cells 12 arranged in rows in one direction. In the following description, the “X-direction” refers to the direction in which the battery cells 12 are arranged, and the “Y-direction” refers to the direction perpendicular to the X-direction. The “Z-direction”, which is orthogonal to the X-direction and the Y-direction, refers to the up-down direction. The term “above/upward/upper side” refers to the side from which the battery wiring module 10 is attached to the battery 11. That is, the battery 11 has a module attachment surface 13, which is an upper surface to which the battery wiring module 10 is attached. Although the Z-direction corresponds to the up-down direction for convenience of description, this does not necessarily mean that the Z-direction of the battery wiring module 10 is set to the vertical direction.

Each battery cell 12 has two battery terminals 14. One of the two battery terminals 14 is a positive terminal, and the other one is a negative terminal. When the battery cells 12 are arranged in the X-direction, the two battery terminals 14 are arranged along the Y-direction on the upper surface of the battery cells 12.

### Configuration of Battery Wiring Module 10

The battery wiring module 10 includes a plurality of electric wires 21 that are electrically connected to the battery 11, and a case 22 for housing the electric wires 21. The battery wiring module 10 also includes a plurality of busbars 23, which are supported by the case 22, for example. The busbars 23 are located on both sides in the Y-direction of the case 22, and are arranged side by side along the X-direction. Each busbar 23 connects battery terminals 14 that are adjacent to each other in the X-direction. The busbars 23 are connected to the battery terminals 14 by welding, for example. Each busbar 23 is electrically connected to a corresponding electric wire 21. The busbars 23 form conductive paths together with the electric wires 21. Each electric wire 21 is, for example, a detection wire for detecting the voltage of the corresponding busbar 23. Each electric wire 21 is connected to a connector 24 for connecting to a detection device (not shown). The battery wiring module 10 also includes a cover 25 that covers the upper side of the case 22.

### Configuration of Case 22

The case 22 is made of an insulating material, such as synthetic resin. The case 22 has first busbar holders 26 and second busbar holders 27. The first busbar holders 26 have a shape different from the second busbar holders 27. A plurality of first busbar holders 26 and a plurality of second busbar holders 27 are arranged alternately in the X-direction. The first busbar holders 26 and the second busbar holders 27 form two rows in correspondence with two rows of the busbars 23 that are arranged in the X-direction. A pair of a first busbar holder 26 and a second busbar holder 27 that are adjacent to each other in the X-direction hold one busbar 23. Each busbar 23 spans between the first busbar holder 26 and the second busbar holder 27 that are adjacent to each other in the X-direction.

The case 22 has sensor housing parts 30. The sensor housing part 30 houses a temperature sensor 60 for detecting the temperature of the battery 11.

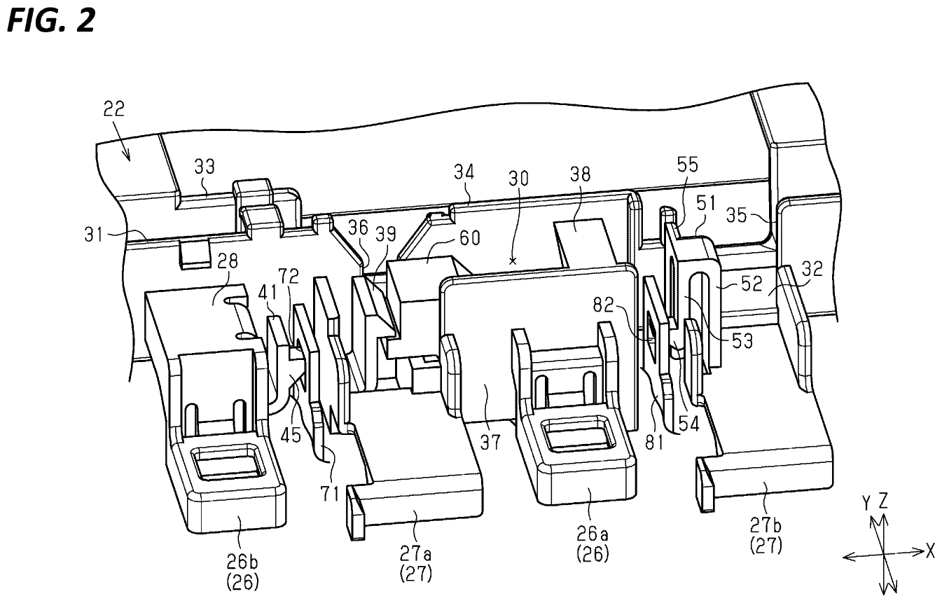

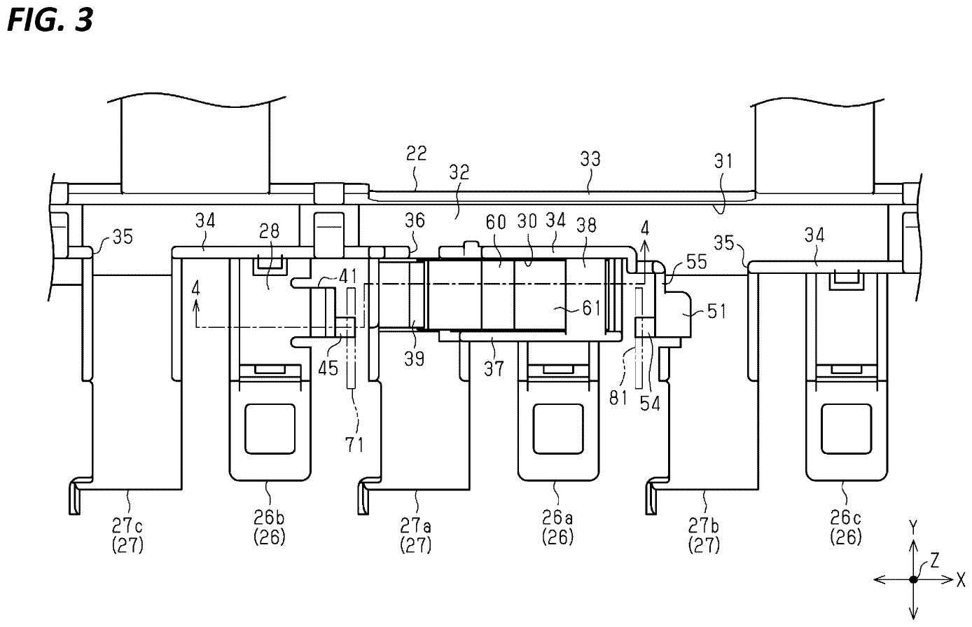

FIGS. 2 and 3 show a region around the sensor housing part 30 in the case 22. The case 22 has a wire housing part 31, which extends in the X-direction. The wire housing part 31 has a bottom wall 32, and a pair of side walls 33 and 34 that face each other in the Y-direction. The lower face of the bottom wall 32 faces the aforementioned module attachment surface 13 in the Z-direction. The side walls 33 and 34 extend upward from the bottom wall 32. The electric wire 21 is housed in a space between the side walls 33 and 34 that are spaced apart in the Y-direction. Note that, of the two side walls 33 and 34, the side wall 33 is a side wall located inward in the Y-direction, and the side wall 34 is a side wall located outward in the Y-direction. The first busbar holders 26 and the second busbar holders 27 are located outward in the Y-direction of the wire housing part 31. Note that the upper side of the wire housing part 31, which is open, is covered by the cover 25.

The sensor housing part 30 spans between one first busbar holder 26 and one second busbar holder 27 that are adjacent to each other in the X-direction. In the following description, the first busbar holder 26 and the second busbar holder 27 on which the sensor housing part 30 is formed are referred to as a first busbar holder 26a and a second busbar holder 27a, respectively. A first busbar holder 26b refers to a first busbar holder 26 that is adjacent to the second busbar holder 27a in the X-direction and located on the opposite side to the first busbar holder 26a. A second busbar holder 27b refers to a second busbar holder 27 that is adjacent to the first busbar holder 26a in the X-direction and located on the opposite side to the second busbar holder 27a. As shown in FIG. 3, first busbar holders 26c refer to the first busbar holders 26 other than the first busbar holders 26a and 26b. Second busbar holders 27c refer to the second busbar holders 27 other than the second busbar holders 27a and 27b.

As shown in FIG. 3, the first busbar holders 26b and 26c and the second busbar holders 27b and 27c extend outward in the Y-direction from the wire housing part 31. The first busbar holder 26a and the second busbar holder 27a extend outward in the Y-direction from the sensor housing part 30. The side wall 34 of the wire housing part 31 has first openings 35 at positions corresponding to the second busbar holders 27b and 27c. The side wall 34 of the wire housing part 31 also has a second opening 36 at a position corresponding to the second busbar holder 27a. Each electric wire 21 is pulled from inside the wire housing part 31 to the outside in the Y-direction through the first opening 35 or the second opening 36.

### Configuration of Sensor Housing Part 30

As shown in FIGS. 2 and 3, the case 22 has an opposing wall 37 that spans between the first busbar holder 26a and the second busbar holder 27a. The opposing wall 37 is located outward in the Y-direction of the side wall 34 of the wire housing part 31. The opposing wall 37 is, for example, parallel with the side wall 34. The opposing wall 37 faces the side wall 34 in the Y-direction. The first busbar holder 26a extends outward in the Y-direction from the opposing wall 37.

The sensor housing part 30 is located between the side wall 34 and the opposing wall 37. Further, the sensor housing part 30 is located between the first busbar holder 26a and the wire housing part 31. The sensor housing part 30 has a spring support 38. The spring support 38 connects the side wall 34 and the opposing wall 37.

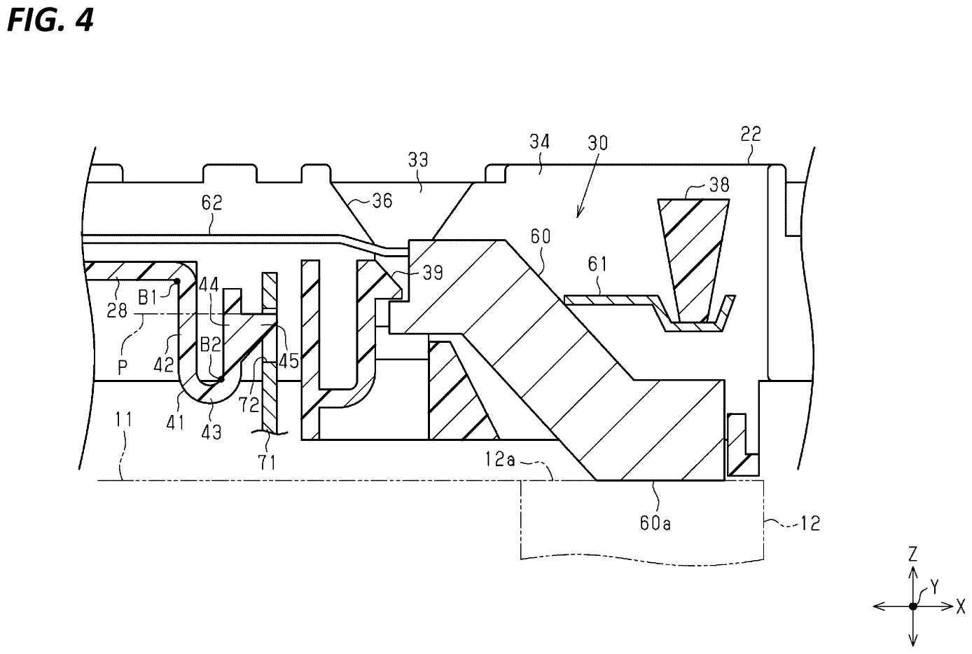

As shown in FIG. 4, the sensor housing part 30 houses the temperature sensor 60 and a spring member 61. The spring member 61 is located between the temperature sensor 60 and the spring support 38. The spring member 61 biases the temperature sensor 60 downward. The temperature sensor 60 is, for example, a thermistor. The temperature sensor 60 has a temperature detection surface 60a. The biasing force of the spring member 61 presses the temperature detection surface 60a of the temperature sensor 60 against an upper surface 12a of a battery cell 12.

The temperature sensor 60 has a lead wire 62 for signal transmission. Note that the lead wire 62 is omitted in FIGS. 2 and 3 for convenience of illustration. The case 22 has a holding claw 39 for holding the temperature sensor 60. The lead wire 62 extends from the temperature sensor 60, passes above the holding claw 39, and is pulled out. As shown in FIG. 2, the holding claw 39 is located at the base end of the second busbar holder 27a.

### Configuration of First Extension Piece 41

As shown in FIG. 2, the case 22 has a first extension piece 41 and a second extension piece 51 on respective sides in the X-direction of the sensor housing part 30.

The first extension piece 41 is located at a base end 28 of the first busbar holder 26b. The first extension piece 41 has a first portion 42, a folded part 43, a second portion 44, and a first locking part 45, as shown in FIG. 4. The first portion 42 extends downward in the Z-direction from the base end 28 of the first busbar holder 26 that serves as a base portion. That is, the first portion 42 extends toward the battery 11. The second portion 44 is folded back from the first portion 42 and extends away from the battery 11. That is, the folded part 43 is located between the first portion 42 and the second portion 44. The second portion 44 extends upward in the Z-direction from the folded part 43. The first extension piece 41 forms a substantially U-shaped folded shape protruding toward the battery 11 due to the first portion 42, the folded part 43, and the second portion 44. Thus, the first extension piece 41 is bendable in the X-direction.

The first locking part 45 is provided in the second portion 44. The first locking part 45 protrudes in the X-direction from the second portion 44 to the opposite side to the first portion 42. When the case 22 is in a state attached to the battery 11, the first locking part 45 is locked to a first locked part 71 that is provided on the battery 11. The first locked part 71 is a portion of the battery 11 that extends upward from the battery 11. For example, the first locking part 45 is inserted into a locking hole 72 provided in the first locked part 71. The first locking part 45 is then caught on the upper side in the Z-direction of the locking hole 72. The first extension piece 41 thus holds the case 22 such that the case 22 is not separated from the battery 11 in the Z-direction.

The first extension piece 41 has a first bending point B1 that is set at the base end of the first portion 42, and a second bending point B2 that is set in the folded part 43, as shown in FIG. 4. The first bending point B1 is set at the base end of the first portion 42, i.e., a portion where the first portion 42 is connected to the base end 28 of the first busbar holder 26b.

The first bending point B1 is located above the first locking part 45 in the Z-direction. The second bending point B2 is located below the first locking part 45 in the Z-direction. That is, the second bending point B2 is located on the battery 11 side relative to the first locking part 45, while the first bending point B1 is located on the opposite side to the battery 11 relative to the first locking part 45. More specifically, the first bending point B1 is located above a virtual plane P that is perpendicular to the Z-direction and passes through the first locking part 45, i.e., on the opposite side of the virtual plane P from the battery. The second bending point B2 is located below the virtual plane P, i.e. on the battery 11 side of the virtual plane P.

The lead wire 62 of the temperature sensor 60 is pulled out from the temperature sensor 60 toward the first extension piece 41 in the X-direction. Further, the lead wire 62 passes above the holding claw 39 and the first extension piece 41. That is, the lead wire 62 passes through an empty space above the first extension piece 41. Note that the upper surface of the base end 28 of the first busbar holder 26b and the upper end of the holding claw 39 are set at the same position in the Z-direction. The upper end of the second portion 44 of the first extension piece 41 is located below the upper surface of the base end 28 and the upper end of the holding claw 39.

(Configuration of second extension piece 51) As shown in FIG. 2, the second extension piece 51 is located at a base end of the second busbar holder 27b. The second extension piece 51 has, for example, a third portion 52, a fourth portion 53, and a second locking part 54. The third portion 52 extends upward in the Z-direction from the base end of the second busbar holder 27b. That is, the third portion 52 extends away from the battery 11. The fourth portion 53 is folded back into a substantially U-shape from the upper end of the third portion 52 and extends downward in the Z-direction. That is, the fourth portion 53 is folded back from the third portion 52 and extends toward the battery 11. The second extension piece 51 is bendable in the X-direction due to the substantially U-shape formed by the third portion 52 and the fourth portion 53. Further, the case 22 has, for example, a joint wall 55 that connects the second extension piece 51 and the side wall 34.

The second locking part 54 protrudes in the X-direction from the lower end of the fourth portion 53, for example. The second locking part 54 protrudes from the fourth portion 53 to the opposite side to the third portion 52. When the case 22 is in a state attached to the battery 11, the second locking part 54 is locked to a second locked part 81 that is provided on the battery 11. The second locked part 81 is a portion of the battery 11 that extends upward from the battery 11. For example, the second locking part 54 is inserted into a locking hole 82 provided in the second locked part 81. The second locking part 54 is then caught on the upper side in the Z-direction of the locking hole 82. The second extension piece 51 thus holds the case 22 such that the case 22 is not separated from the battery 11 in the Z-direction.

Next, the bending of the first extension piece 41 when the case 22 is attached to the battery 11 will be described.

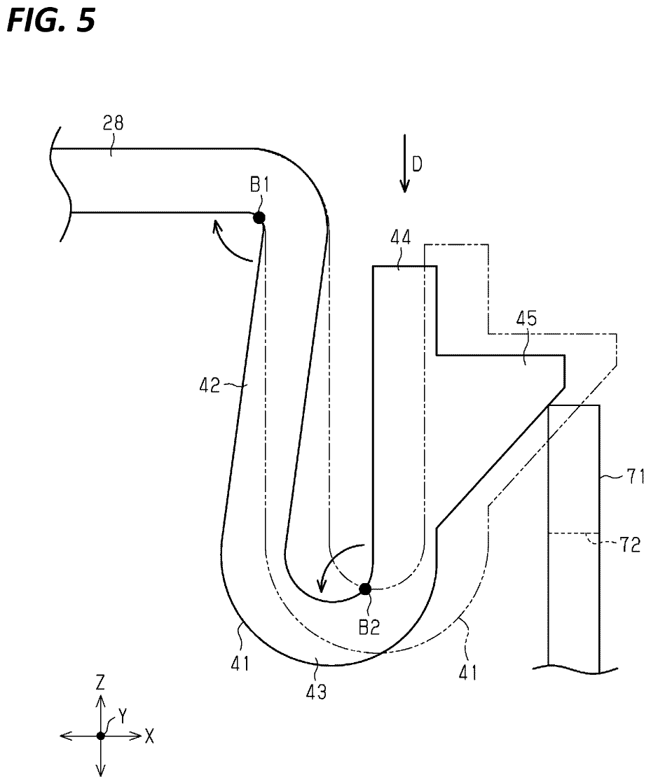

As shown in FIG. 5, the case 22, including the first extension piece 41, is fitted to the battery 11 in a fitting direction D parallel with the Z-direction. In FIG. 5, the first extension piece 41 that is not in a bent state is indicated by a two-dot chain line, and the first extension piece 41 in a bent state due to contact with the first locked part 71 is indicated by a solid line. When the first locking part 45 comes into contact with the leading end of the first locked part 71 along the fitting direction D, the first extension piece 41 is bent with the first bending point B1 and the second bending point B2 as centers. Here, the second bending point B2 is located on the battery 11 side relative to the first locking part 45, and the first bending point B1 is located on the opposite side relative to the first locking part 45 from the battery 11, as mentioned above. Thus, the rotation direction of the bending with the first bending point B1 as the center is opposite to the rotation direction of the bending with the second bending point B2 as the center, as indicated by the arrows in FIG. 5. In the side view shown in FIG. 5, the first portion 42 is bent in a clockwise direction with the first bending point B1 as the center, and the second portion 44 is bent in a counterclockwise direction with the second bending point B2 as the center. As a result of the first portion 42 being bent in a clockwise direction with the first bending point B1 as the center, the first locking part 45 is displaced slightly downward when pressed by the first locked part 71. This makes it easy for the first locking part 45 to enter the locking hole 72 in the first locked part 71.

Next, operation of the present embodiment will be described.

When the case 22 is in a state attached to the battery 11, the spring support 38 of the sensor housing part 30 receives a force in a direction pushing the spring support 38 upward from the spring member 61, which applies a biasing force to the temperature sensor 60. Here, the first extension piece 41 and the second extension piece 51 located on the respective sides in the X-direction of the sensor housing part 30 are locked to the first locked part 71 and the second locked part 81, respectively. That is, the force of the spring member 61 pushing up the spring support 38 can be received by the first extension piece 41 and the second extension piece 51. Therefore, the force of the spring member 61 can suppress the rising of the sensor housing part 30 from the battery 11.

Effects of the present embodiment will be described.
(1) The first extension piece 41 has a first portion 42 that extends toward the battery 11, a second portion 44 that is folded back from the first portion 42 and extends away from the battery 11, and a first locking part 45 that is provided in the second portion 44 and is locked to the first locked part 71. According to this configuration, the first extension piece 41 that is locked to the first locked part 71 of the battery 11 can hold the case 22 such that the case 22 is not separated from the battery 11. This can suppress the rising of the case 22. Further, the first extension piece 41 is bendable due to the folded shape formed by the first portion 42 and the second portion 44. This allows the first locking part 45 provided in the second portion 44 to be more easily locked to the first locked part 71. Further, the first portion 42 and the second portion 44 form a folded shape that protrudes toward the battery 11. With this, space can be secured on the opposite side to the battery 11 relative to the first extension piece 41.
(2) The first extension piece 41 has a first bending point B1 that is set at the base end of the first portion 42, and a second bending point B2 that is set in the folded part 43 between the first portion 42 and the second portion 44. According to this configuration, the first bending point B1 and the second bending point B2 can make the first extension piece 41 more bendable. This allows the first locking part 45 provided in the second portion 44 to be more easily locked to the first locked part 71.
(3) When the battery 11 side relative to the first extension piece 41 is the lower side, and the opposite side is the upper side, the first bending point B1 is located on the upper side relative to the first locking part 45. The second bending point B2 is located on the lower side relative to the first locking part 45. According to this configuration, the second portion 44 is bent in a direction approaching the first portion 42 with the second bending point B2 as the center when the case 22 is fitted to the battery 11. The first portion 42 is bent in a direction away from the first locked part 71 with the first bending point B1 as the center. As a result, the first locking part 45 is displaced downward, i.e., toward the battery 11 when engaging with the first locked part 71. This makes it easy for the first locking part 45 to enter the locking hole 72 in the first locked part 71. Accordingly, the first locking part 45 can be preferably locked to the first locked part 71 by setting the positions of the first locking part 45, the first bending point B1, and the second bending point B2 in the above-described positional relationship.
(4) The case 22 has a sensor housing part 30 for housing the temperature sensor 60 for detecting the temperature of the battery 11. The temperature sensor 60 has a lead wire 62. The lead wire 62 passes above the first extension piece 41. According to this configuration, the lead wire 62 of the temperature sensor 60 passes through the space above the first extension piece 41, allowing for efficient use of this space.
(5) The case 22 has a second extension piece 51 that is locked to the second locked part 81 provided on the battery 11. The sensor housing part 30 is located between the first extension piece 41 and the second extension piece 51. According to this configuration, the first extension piece 41 and the second extension piece 51 can hold the case 22 on the respective sides of the sensor housing part 30 such that the case 22 is not separated from the battery 11. This can more preferably suppress the rising of a region of the case 22 including the sensor housing part 30.
(6) The second extension piece 51 has a third portion 52 that extends away from the battery 11, and a fourth portion 53 that is folded back from the third portion 52 and extends toward the battery 11. Further, the second extension piece 51 has a second locking part 54 that is provided in the fourth portion 53 and locked to the second locked part 81. According to this configuration, the second extension piece 51 is bendable due to the folded shape formed by the third portion 52 and the fourth portion 53, enabling the second locking part 54 provided in the fourth portion 53 to be easily locked to the second locked part 81. Since the lead wire 62 of the temperature sensor 60 passes above the first extension piece 41, the positioning of the lead wire 62 is not affected even if space is not secured above the second extension piece 51. Thus, the second extension piece 51 can be configured using upper space.

### Modifications

The present embodiment can be modified as follows when implemented. The present embodiment and the following modifications can be implemented in combination as long as no technical contradiction arises.
In the above embodiment, the second extension piece 51 may have the same configuration as the first extension piece 41.
In the first extension piece 41 of the above embodiment, the base end of the first portion 42 and the first bending point B1 may be set to be below the virtual plane P. That is, the base end of the first portion 42 and the first bending point B1 may be set to be below the first locking part 45.
The protrusion/recess relationship in the locking structure between the first extension piece 41 and the first locked part 71 may be inverted from the relationship in the above embodiment. That is, it is possible to provide the first locked part 71 with a protrusion and provide the second portion 44 with a recess to serve as a first locking part into which that protrusion is inserted. Similarly, it is possible to provide the second locked part 81 with a protrusion and provide the fourth portion 53 with a recess to serve as a second locking part into which that protrusion is inserted.
In the above embodiment, the first extension piece 41 and the second extension piece 51 are located on the respective sides in the X-direction of the sensor housing part 30. In another mode, for example, the first extension piece 41 and the second extension piece 51 may be located on the respective sides in the Y-direction of the sensor housing part 30.
The second extension piece 51 may be omitted from the above embodiment.
The sensor housing part 30 of the above embodiment spans between the first busbar holder 26a and the second busbar holder 27a, but the position at which the sensor housing part 30 is disposed in the case 22 is not specifically limited to the above embodiment.
The embodiment and the modifications disclosed herein are illustrative in all respects, and should not be considered restrictive. That is, the scope of the present invention is defined by the claims, and is intended to encompass all modifications within the meaning and scope equivalent to the claims.

### LIST OF REFERENCE NUMERALS

10 Battery wiring module
11 Battery
12 Battery cell
12a Upper surface
13 Module attachment surface
14 Battery terminal
21 Electric wire
22 Case
23 Busbar
24 Connector
25 Cover
26 (26a, 26b, 26c) First busbar holder (busbar holder)
27 (27a, 27b, 27c) Second busbar holder (busbar holder)
28 Base end
30 Sensor housing part
31 Wire housing part
32 Bottom wall
33, 34 Side wall
35 First opening
36 Second opening
37 Opposing wall
38 Spring support
39 Holding claw
41 First extension piece (extension piece)
42 First portion
43 Folded part
44 Second portion
45 First locking part (locking part)
51 Second extension piece
52 Third portion
53 Fourth portion
54 Second locking part
55 Joint wall
60 Temperature sensor
60a Temperature detection surface
61 Spring member
62 Lead wire
71 First locked part (locked part)
72 Locking hole
81 Second locked part (locked part)
82 Locking hole
B1 First bending point
B2 Second bending point
D Fitting direction
P Virtual plane

1. A battery wiring module that is attachable to a battery, the battery wiring module comprising:
an electric wire to be electrically connected to the battery; and
a case housing the electric wire,
wherein the case has an extension piece to be locked to a locked part provided on the battery, and
the extension piece has: a first portion extending toward the battery; a second portion folded back from the first portion and extending away from the battery; and a locking part provided in the second portion and to be locked to the locked part.

2. The battery wiring module according to claim 1,
wherein the extension piece has: a first bending point set at a base end of the first portion; and a second bending point set in a folded part between the first portion and the second portion.

3. The battery wiring module according to claim 2,
wherein, when the battery side relative to the extension piece is a lower side, and an opposite side thereto is an upper side,
the first bending point is located on the upper side relative to the locking part, and
the second bending point is located on the lower side relative to the locking part.

4. The battery wiring module according to claim 1,
wherein the case has a sensor housing part for housing a temperature sensor for detecting a temperature of the battery,
the temperature sensor has a lead wire, and
when the battery side relative to the extension piece is a lower side, and an opposite side thereto is an upper side, the lead wire passes on the upper side of the extension piece.

5. The battery wiring module according to claim 4,
wherein, when the extension piece is a first extension piece, and the locked part is a first locked part,
the case has a second extension piece to be locked to a second locked part provided on the battery, and
the sensor housing part is located between the first extension piece and the second extension piece.

6. The battery wiring module according to claim 5,
wherein, when the locking part of the first extension piece is a first locking part,
the second extension piece has: a third portion extending away from the battery; a fourth portion folded back from the third portion and extending toward the battery; and a second locking part provided in the fourth portion and to be locked to the second locked part.
